(19) United States
(12) Patent Application Publication
(10) Pub. No.: US 2010/0027155 A1
(43) Pub. Date: Feb. 4, 2010

(54) MAGNETIC DISK APPARATUS AND METHOD FOR CONTROLLING PROJECTING AMOUNT OF MAGNETIC HEAD

(75) Inventor: Masakazu Taguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/479,334

(22) Filed: Jun. 5, 2009

(30) Foreign Application Priority Data
Jul. 30, 2008 (JP) 2008-196173

(51) Int. Cl. G11B 21/02

(52) U.S. Cl. 360/75; G9B/21.003

(57) ABSTRACT

A magnetic disk apparatus includes a magnetic disk, and a magnetic head facing the magnetic disk. The magnetic disk apparatus also includes a thermal deforming member and a thermal deformation controller. The thermal deforming member is provided in the magnetic head for thermally deforming the magnetic head to change the projecting amount of the magnetic head toward the magnetic disk. The thermal deformation controller controls the driving power supplied to the thermal deforming member, so that the falling characteristic of the driving power in transition from an on-state to an off-state is gentler in inclination than the rising characteristic of the driving power in transition from an off-state to an on-state.

### FIELD

An embodiment discussed herein relates to a magnetic disk apparatus having the function to control the DFH (Dynamic Flying Height) by controlling the projecting amount of a magnetic head. Another embodiment relates to a method for controlling the projecting amount of a magnetic head.

### BACKGROUND

A technique to control the projecting amount of a magnetic head to control the DFH is discussed in Japanese Laid-open Patent Publication No. 2007-234127, for example. The magnetic head incorporates a recording element, a reproducing element and a heater. The heater can change the projecting amount of the magnetic head toward a magnetic disk due to thermal expansion. Specifically, when the heater is driven for heating, the projecting amount increases due to thermal expansion, so that the distance between the magnetic head and the magnetic disk reduces. When the heating of the heater is stopped, the projecting amount of the magnetic head reduces, so that the distance between the magnetic head and the magnetic disk increases. With this arrangement, the magnetic head is disposed as close to the magnetic disk as possible in recording and reproducing.

### SUMMARY

According to a first aspect of the present invention, there is provided a magnetic disk apparatus including: a magnetic disk; a magnetic head with a recording element and a reproducing element, where the magnetic head is arranged to face a surface of the magnetic disk. The magnetic disk apparatus also includes a thermal deforming member and a thermal deformation controller. The thermal deforming member is provided in the magnetic head for thermally deforming the magnetic head to change a projecting amount of the magnetic head toward the magnetic disk. The thermal deformation controller controls the driving power supplied to the thermal deforming member in such a manner that the falling characteristic of the driving power in transition from an on-state to an off-state is gentler in inclination than the rising characteristic of the driving power in transition from an off-state to an on-state.

According to a second aspect of the present invention, there is a projecting amount controlling method for a magnetic head arranged to face a surface of a magnetic disk, where the magnetic head is provided with a recording element, a reproducing element and a thermal deforming member. According to the method, the projecting amount of the magnetic head toward the magnetic disk is changed by causing the thermal deforming member to thermally deform at least part of the magnetic head. Also, the driving power for the thermal deforming member is controlled in such a manner that the falling characteristic of the driving power in transition from an on-state to an off-state is to be gentler in inclination than the rising characteristic of the driving power in transition from an off-state to an on-state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating a magnetic disk apparatus;

FIG. 2 is a block diagram illustrating a heater control circuit;

FIG. 3 is a time chart for describing a method for controlling the projecting amount of a magnetic head;

FIG. 4 is a time chart for describing the change in floating amount of the magnetic head;

FIG. 5 is a time chart for describing a method for controlling the projecting amount of a magnetic head;

FIG. 6 is a time chart for describing a method for controlling the projecting amount of a magnetic head;

FIG. 7 is a time chart for describing a method for controlling the projecting amount of a magnetic head; and

FIG. 8 is a time chart for describing a change in floating amount of a magnetic head.

### DESCRIPTION OF EMBODIMENTS

An embodiment of the present invention will be described below. The apparatus according to an embodiment of the present invention includes a magnetic disk, a magnetic head and a thermal deformation controller. The magnetic head is arranged to face a surface of the magnetic disk. The magnetic head includes a recording element, a reproducing element and a thermal deforming member. The thermal deforming member changes the projecting amount of the magnetic head toward the magnetic disk by thermal deformation. The thermal deformation controller controls the thermal deforming member by turning on and off the electricity. Specifically, thermal deformation controller controls a driving power for driving the thermal deforming member in such a manner that the falling characteristic of the driving power in transition from the on-state to the off-state is gentler in inclination than the rising characteristic of the driving power in transition from the off-state to the on-state.

According to the embodiment of the present invention, in controlling the thermal deforming member by turning on and off the electricity, the driving power is so controlled that the falling characteristic of the driving power in transition from the on-state to the off-state have a gentler inclination than the inclination of the rising characteristic of the driving power in transition from the off-state to the on-state. With this arrangement, in the transition from the on-state to the off-state, the air flow between the magnetic disk and the magnetic head is not disturbed, so that the floating amount of the entirety of the magnetic head reaches a steady level without transient response. Thus, the posture of the magnetic head is kept stable, and the magnetic head is prevented from coming into contact with the magnetic disk.

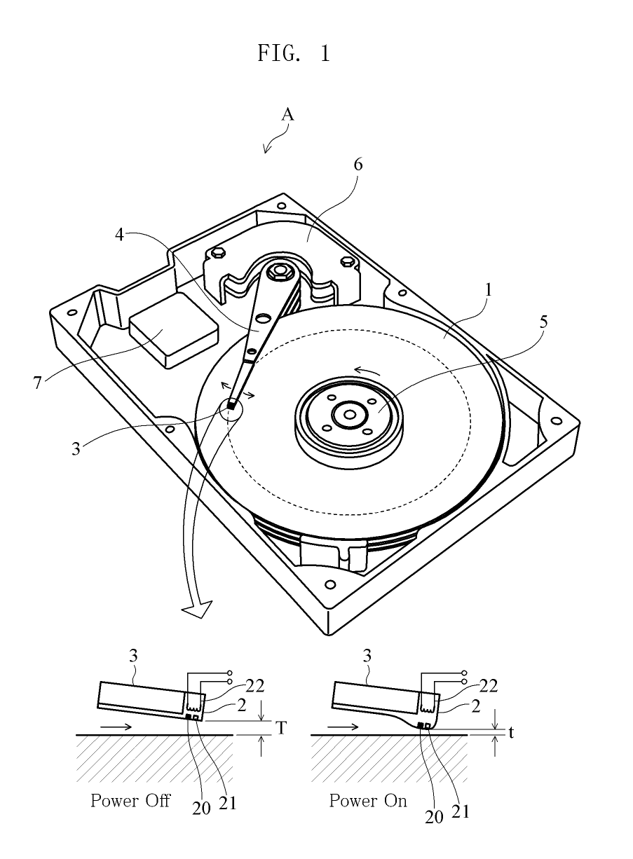

FIGS. 1-4 illustrate a magnetic disk apparatus according to an embodiment of the present invention. As illustrated in FIG. 1, the magnetic disk apparatus A includes a magnetic disk 1, a magnetic head 2, a slider 3, a swing arm 4, a spindle motor 5, a voice coil motor 6 and a disk controller 7.

As the magnetic disk 1, a plurality of disks, each of which has opposite recording surfaces, are arranged with intervals in the vertical direction. In this embodiment, use is made of magnetic disks having a diameter of 3.5 inches. The magnetic disk 1 is rotated by the spindle motor 5 at a high rotational speed of e.g. 6000 rpm. When the magnetic disk 1 has an outer radius of 44 mm, an intermediate radius of 34 mm and an inner radius of 24 mm, the circumferential speed is 27.6 m/s at the outer radius position, 21.4 m/s at the intermediate radius position and 15.1 m/s at the inner radius position. Thus, when the rotational speed of the disk is maintained at 6000 rpm, the circumferential speed varies by about ±30% relative to the circumferential speed at the intermediate radius position. As the magnetic disk 1, use may be made of a magnetic disk having a diameter of 2.5 inches, 1.8 inches, 1 inch or 0.85 inch.

The magnetic head 2 is for reading and writing magnetic information with respect to the magnetic disk 1. The magnetic head 2 is incorporated in the slider 3 in such a manner as to face the recording surface of the magnetic disk 1. The magnetic head 2 includes, as a magnetic operational portion, a reproducing element 20 and a recording element 21 for individually performing reading and writing of magnetic information. The magnetic head 2 further includes a heater 22 as a thermal deforming member. The heater 22 functions to change the projecting amount of the magnetic head 2 toward the magnetic disk 1 utilizing thermal expansion. Specifically, when the heater 22 is turned on by the application of a driving voltage, the heater 22 causes the magnetic head 2 to thermally expand, so that the projecting amount of the magnetic head 2 increases. That is, when the heater 22 is in the on-state, the distance t between the magnetic disk 1 and the magnetic head 2 is reduced. Conversely, when the heater 22 is in the off-state, the projecting amount of the magnetic head 2 reduces due to heat shrinkage, so that the distance T between the magnetic disk 1 and the magnetic head 2 is increased. As the base material of the magnetic 2, use may be made of a soft magnetic material having a high magnetic permeability. The projecting amount of the magnetic head 2 is increased after the magnetic head 2 is properly positioned relative to the track with respect to which reading or writing is to be performed by seeking operation.

The slider 3 is attached to an end of the swing arm 4 via a suspension. Because of the airflow produced between the slider 3 and the magnetic disk 1 due to the high speed rotation of the disk 1, the slider 3 floats above the disk 1 with slight inclination. The slider 3 has a size of e.g. not more than 1 mm×1 mm and an extremely small weight of e.g. about 0.6 mg. The floating amount of the end of the slider 3, which is on the flow-in side of the air flow from the magnetic disk 1, is about 50 to 150 nm. The floating amount of the entirety of the magnetic head 2, which is on the flow-out side of the air flow, is about 5 to 15 nm. It is to be noted that the floating amount of the magnetic head 2 differs from the distance T and the minimum distance t between the magnetic head 2 and the magnetic disk 1. The floating amount of the magnetic head 2 is defined as a distance measured between the magnetic disk 1 and a predetermined reference position of the magnetic head 2.

The swing arm 4 is pivoted by the voice coil motor 6 to reciprocally move the magnetic head 2 and the slider 3 in a substantially radial direction of the magnetic disk 1. The spindle motor 5 rotates the magnetic disk 1 at high speed. The disk controller 7 is for controlling the reproducing element 20, recording element 21 and heater 22 of the magnetic head 2, the spindle motor 5 and the voice coil motor 6.

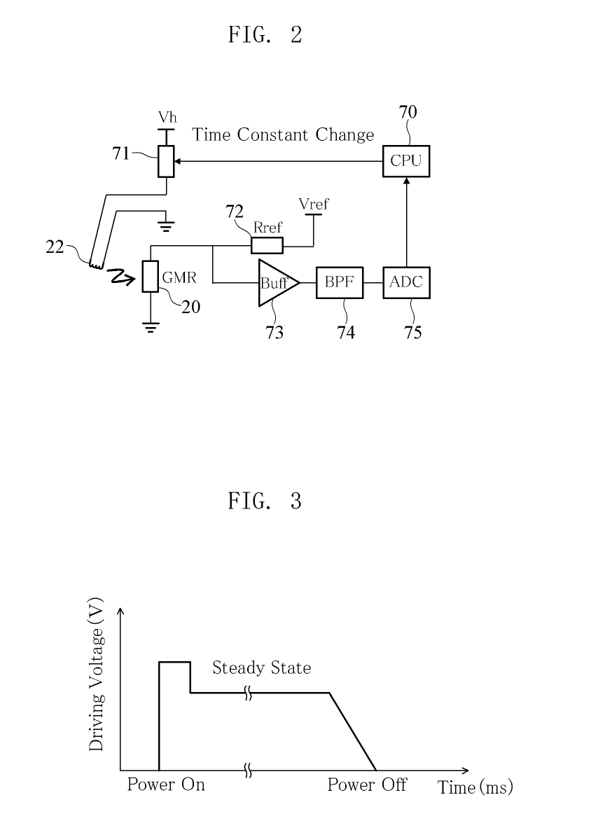

The disk controller 7 may be a wired logic circuit including a microcomputer. The disk controller 7 includes a heater control circuit for controlling the heater 22 by turning on and off the electricity. The heater control circuit functions as a thermal deformation controller. As illustrated in FIG. 2, the heater control circuit includes a CPU 70, a time constant variable element 71, a reference resistor 72, a buffer 73, a band-pass filter 74 and an AD converter 75. The time constant variable element 71 is connected to the heater 22. The reference resistor 72 is connected to the reproducing element 20. The reproducing element 20 may be a GMR element.

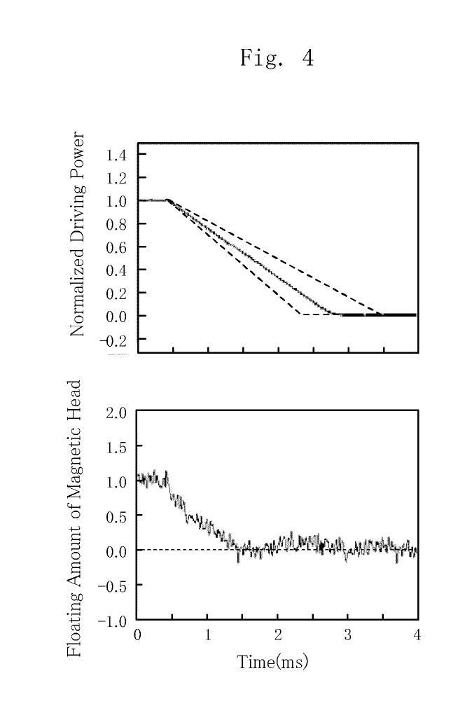

The CPU 70 controls the heater 22 by turning on and off the electricity based on such a driving voltage waveform as illustrated in FIG. 3. In this driving voltage waveform, the rising waveform in the transition from the off-state to the on-state is steep and temporarily exceeds the steady level before it reaches a steady state. The falling waveform in the transition from the on-state (steady state) to the off-state is gentler than the rising waveform. The inclination of the rising waveform and the falling waveform can be changed by changing the time constant by the CPU 70 via the time constant variable element 71. The time constant variable element 71 may be a variable capacitor. By changing the capacitance of the variable capacitor, the time constant, which is determined from the heater 2 and the time constant variable element 71, can be changed. When the time constant is reduced, the inclination of the waveform increases. Conversely, when the time constant is increased, the inclination of the waveform reduces. In this embodiment, the CPU 70 detects a change in resistance of the reproducing element 20 via the reference resistor 72, the buffer 73, the band-pass filter 74 and the AD converter 75. Based on the change in resistance, the CPU 70 estimates the ambient temperature and controls the time constant by feed back control. The circumferential speed of the magnetic disk 1 varies between the outer circumferential position and the inner circumferential position. As indicated by broken lines in FIG. 4, with respect to e.g. the falling waveform, the time constant is controlled correspondingly to such variations in circumferential speed. Due to the air flow speed and the ambient temperature, heat shrinkage due to temperature drop proceeds more easily than thermal expansion, so that a reduction in the projecting amount of the magnetic head 2 tends to be a more rapid change than an increase in the projecting amount. This is the reason why the falling waveform is made gentler than the rising waveform by changing the time constant.

With reference to FIGS. 3 and 4, a method for controlling the projecting amount of the magnetic head 2 will be described.

As illustrated in FIG. 3, when the magnetic head 2 is positioned on a track with respect to which reading or writing is to be performed, a driving voltage is applied to the heater 22 correspondingly to a steep rising waveform. As a result, the projecting amount of the magnetic head 2 increases due to thermal expansion, so that the distance t between the magnetic disk 1 and the magnetic head 2 reduces. In this state, the recording or reproducing operation is started quickly.

In moving the magnetic head 2 to another track after the recording or reproducing operation is finished, the driving voltage is gradually reduced from the steady level (on-state) to zero correspondingly to a gentle falling waveform. As indicated by the solid line in FIG. 4, when the magnetic head is positioned at the intermediate radius position of the magnetic disk 1, the time constant of the falling waveform is controlled to be e.g. about 2.5 ms. The falling waveforms indicated by broken lines in FIG. 4 are the waveforms employed when the magnetic head 2 is positioned at the outer radius position or the inner radius position. As indicated by these lines, the time constant is varied within the range of about 2.2 to 3.0 ms.

During the transition from the on-state to the off-state, the magnetic disk 1 is rotating at high speed, and the heat shrinkage of the magnetic head 2 proceeds more easily than the thermal expansion due to the air flow. By making the falling waveform gentle as illustrated in FIG. 4, the projecting amount of the magnetic head 2 is prevented from suddenly reducing. Thus, the airflow between the magnetic disk 1 and the magnetic head 2 is not disturbed. As a result, the floating amount of the entirety of the magnetic head 2 smoothly converges to the zero level, which is the reference in the off-state, without exhibiting transient response. Thus, the magnetic head 2 is smoothly moved to a track which is the next recording or reproducing position while keeping the stable floating posture.

In this way, in the magnetic disk apparatus A of this embodiment, the driving power is so controlled that the falling waveform in the transition of the heater 22 from the on-state to the off-state is gentler than the rising waveform in the transition from the off-state to the on-state. Thus, even when the projecting amount of the magnetic head 2 reduces in the transition from the on-state to the off-state, the air flow is not disturbed. The floating amount of the entirety of the magnetic head 2 gradually reduces to reach the reference level in the off-state. Thus, the magnetic head 2 is prevented from coming into contact with the magnetic disk 1.

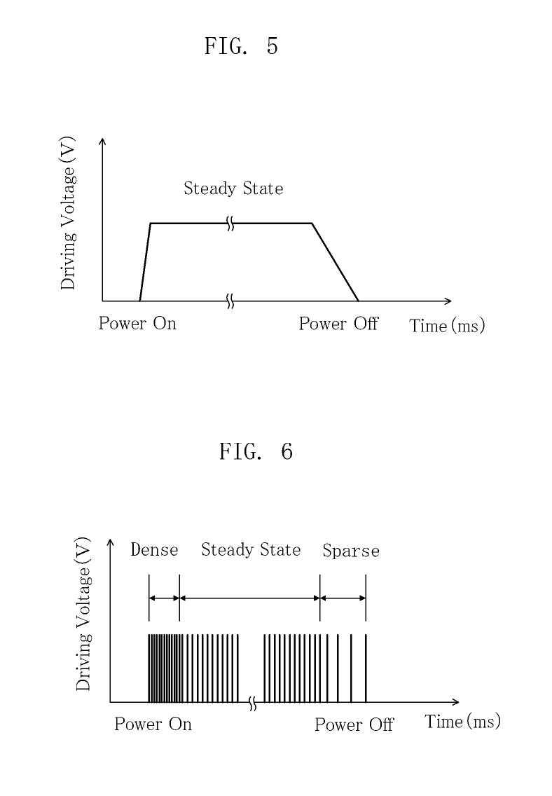

As another embodiment, the driving voltage may be controlled as illustrated in FIG. 5. In this embodiment, the waveform steeply and monotonically rises up to a steady level in the transition from the off-state to the on-state.

As illustrated in FIG. 6, to change the inclination of the rising waveform and the falling waveform of the driving voltage, the driving voltage may be controlled by pulse-density modulation, i.e., by modulating the density of pulses each having a constant width. With this arrangement, the rising waveform can be made steep by increasing the pulse density, whereas the falling waveform can be made gentle by reducing the pulse density. Instead of this, pulse-width modulation or pulse-amplitude modulation may be employed to provide the same effect.

The foregoing embodiments are merely examples and may be varied appropriately in design in accordance with specifications.

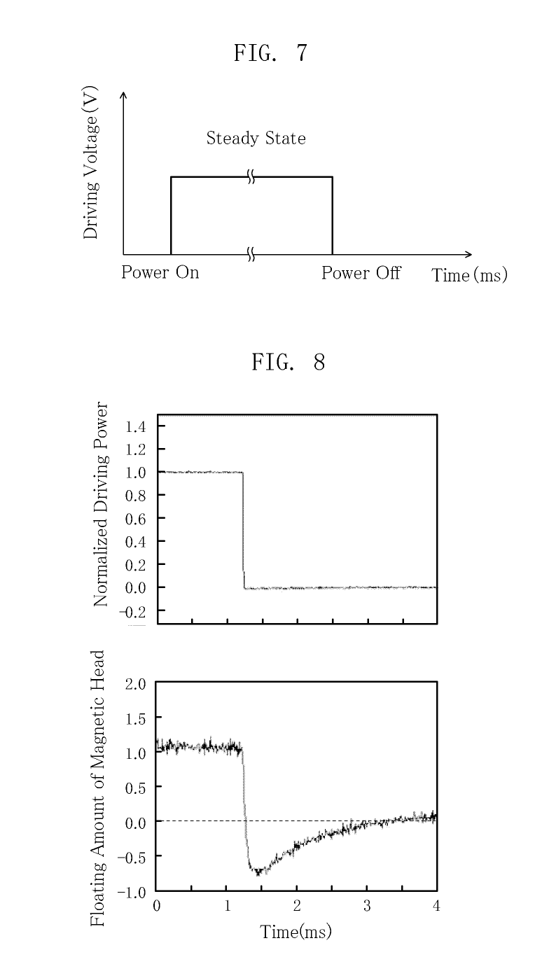

FIG. 7 illustrates a comparative example. In this comparative example, the heater is turned on and off by controlling the driving voltage. The inclination of the rising waveform of the driving voltage in the transition from the off-state to the on-state is the same as that of the falling waveform of the driving voltage in the transition from the on-state to the off-state. This inclination is suitable for causing the projection to occur as quickly as possible. The rise characteristics of the driving voltage are steep. Correspondingly to this, the fall characteristics of the driving voltage are also steep.

In the comparative example, the driving voltage is so controlled that the falling waveform in the transition from the on-state to the off-state be steep similarly to the rising waveform, and the projecting amount of the magnetic head changes following the change in the driving voltage. This control causes the floating amount of the entirety of the magnetic head to be disturbed. That is, in reducing the projecting amount of the magnetic head, the air flow between the magnetic disk and the magnetic head changes suddenly. As a result, as illustrated in FIG. 8, the floating amount of the magnetic head undergoes transient response before it reaches a steady level. Thus, in the comparative example, the posture of the magnetic head cannot be kept stable, and the magnetic head may come into contact with a magnetic disk to damage the disk.

According to the above embodiments, the posture of the magnetic head is kept stable, and the magnetic head is prevented from coming into contact with a magnetic disk. Thus, no drawback accompanying the comparative example occurs.

What is claimed is:

1. A magnetic disk apparatus comprising:
a magnetic disk;
a magnetic head including a recording element and a reproducing element, the magnetic head being arranged to face a surface of the magnetic disk;
a thermal deforming member provided in the magnetic head for thermally deforming the magnetic head to change a projecting amount of the magnetic head toward the magnetic disk; and
a thermal deformation controller for controlling a driving power for driving the thermal deforming member in such a manner that a falling characteristic of the driving power in transition from an on-state to an off-state is gentler in inclination than a rising characteristic of the driving power in transition from an off-state to an on-state.

2. The magnetic disk apparatus according to claim 1, wherein the thermal deformation controller controls the driving power in such a manner that a rising waveform in transition from the off-state to the on-state temporarily exceeds a steady level.

3. The magnetic disk apparatus according to claim 1, wherein the thermal deformation controller controls the driving power by pulse modulation.

4. A projecting amount controlling method for a magnetic head arranged to face a surface of a magnetic disk, the magnetic head including a recording element, a reproducing element and a thermal deforming member, the method comprising:
changing a projecting amount of the magnetic head toward the magnetic disk by causing the thermal deforming member to thermally deform the magnetic head; and
controlling driving power for the thermal deforming member in such a manner that a falling characteristic of the driving power in transition from an on-state to an off-state is gentler in inclination than a rising characteristic of the driving power in transition from an off-state to an on-state.
